(19) United States
(12) Patent Application Publication
(10) Pub. No.: US 2015/0040101 A1
(43) Pub. Date: Feb. 5, 2015

(54) Collaborative Awareness in Software Development

(71) Applicants: Andreas Rummler, Dresden (DE); Tobias Nestler, Dresden (DE)

(72) Inventors: Andreas Rummler, Dresden (DE); Tobias Nestler, Dresden (DE)

(73) Assignee: SAP AG, Walldorf (DE)

(21) Appl. No.: 13/958,944

(22) Filed: Aug. 5, 2013

(51) Int. Cl. G06Q 10/10

(52) U.S. Cl. CPC G06Q 10/101
USPC 717/113

(57) ABSTRACT

Methods, systems, and computer-readable storage media for supporting concurrent activities in distributed development processes. In some implementations, actions include providing source code for display to a first developer, receiving first status information associated with the source code, the first status information being received in response to a determination that a second developer is concurrently accessing the source code, and reflecting a first status of the source code, processing the first status information to provide first collaboration information, and providing the first collaboration information for display to the first developer.

### BACKGROUND

Software can be developed in distributed environments. For example, multiple developers can develop source code. The developers can be dispersed throughout a location, a region, or world-wide. Distributed development of software products includes a range of challenges. An example challenge is following the mutual development progress of individual developers that are members of a development team.

Version Control Systems (VCSs) are implemented to support distributed development of software. Some VCSs manage the access of a centrally hosted source code base. For example, each developer involved in a particular project checks out a local copy of the source code, e.g., for editing, and commits changes back to the central code base. Having done so, other developers can update their local copies of the source code in order to receive the latest changes.

If, for example, multiple developers check out the same source code, and concurrently apply changes, e.g., to a class and/or method), the commit from a first developer will update the central code base. Subsequent commits of other developers may lead to errors. For example, changes made by one or more of the other developers do not take into account changes made by the first developer. Consequently, a merge process is executed to merge the various changes. This merge process, however, can be time consuming and error-prone, and can require significant communication between the involved parties.

### SUMMARY

Implementations of the present disclosure include computer-implemented methods for supporting concurrent activities in distributed development processes. In some implementations, actions include providing source code for display to a first developer, receiving first status information associated with the source code, the first status information being received in response to a determination that a second developer is concurrently accessing the source code, and reflecting a first status of the source code, processing the first status information to provide first collaboration information, and providing the first collaboration information for display to the first developer.

In some implementations, the first collaboration information is specific to a code artifact that is associated with the source code.

In some implementations, the first collaboration information includes an indication of the second developer.

In some implementations, the first collaboration information includes the status of the source code.

In some implementations, the first status includes one of a viewing status indicating that the source code is open within an active window displayed to the second developer, and an opened status indicating that the source code is open within a non-active window displayed to the second developer.

In some implementations, the first status includes one of a changed status indicating that at least one change has been made to the source code by the second developer, and a coding status indicating that the second developer is actively changing the source code.

In some implementations, actions further include monitoring activity of the first developer with respect to the source code, and providing second status information reflecting the activity of the first developer.

In some implementations, the second status information is provided to display second collaboration information to the second developer, the second collaboration information indicating the activity of the first developer.

In some implementations, the status information is received from a synchronization system.

In some implementations, actions further include determining that a post has been associated with the source code, and in response providing post information in the first status information, the post information being included in the first collaboration information displayed to the first developer.

In some implementations, the first status information reflects the first status based on activities of the second developer.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example high-level architecture in accordance with implementations of the present disclosure.

FIGS. 2A and 2B depict respective screen-shots in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are generally directed to a presence system that provides collaboration information in distributed software development processes. More specifically, implementations of the present disclosure provide collaboration information on the level of individual code artifacts. In some examples, code artifacts are unique to the particular programming language of the code. Example code artifacts for Java, for example, can include a class, a method, and a definition, e.g., of an interface or variable. In some examples, the collaboration information can include presence information, and/or awareness information. In some examples, the presence information can indicate the presence of one or more other developers that are concurrently accessing source code, and/or are working on code artifacts. In some examples, awareness information can indicate activities being performed on code artifacts, and/or a status associated with code artifacts. The collaboration information can be displayed to developers that are currently accessing the same source code. In this manner, the presence of concurrently working developers can be made known, and awareness as to activities performed by other developers can be provided.

In accordance with implementations of the present disclosure, it can be determined whether multiple developers are concurrently accessing the same source code, and/or concurrently editing the same code artifact. Collaboration information can be generated, and can be provided to each of the multiple developers for display. For example, each developer can access the source code using an integrated development environment (IDE). The collaboration information can be displayed to each developer through a respective IDE. In this manner, each developer is provided information to better understand concurrent activities of other developers, without interrupting their current tasks. For example, there is no need to leave the workspace or IDE in order to communicate with the other developers, e.g., call, text, email. In some examples, the presence and awareness information enables individual developers to decide whether it is worth beginning work on the same artifact being worked on by other developers, or wait until changes are committed, e.g., to a central code base. In this manner, productivity of the development team is positively impacted, e.g., saving time lost to unnecessary merges, reducing the potential of occurring errors due to a higher transparency within the group.

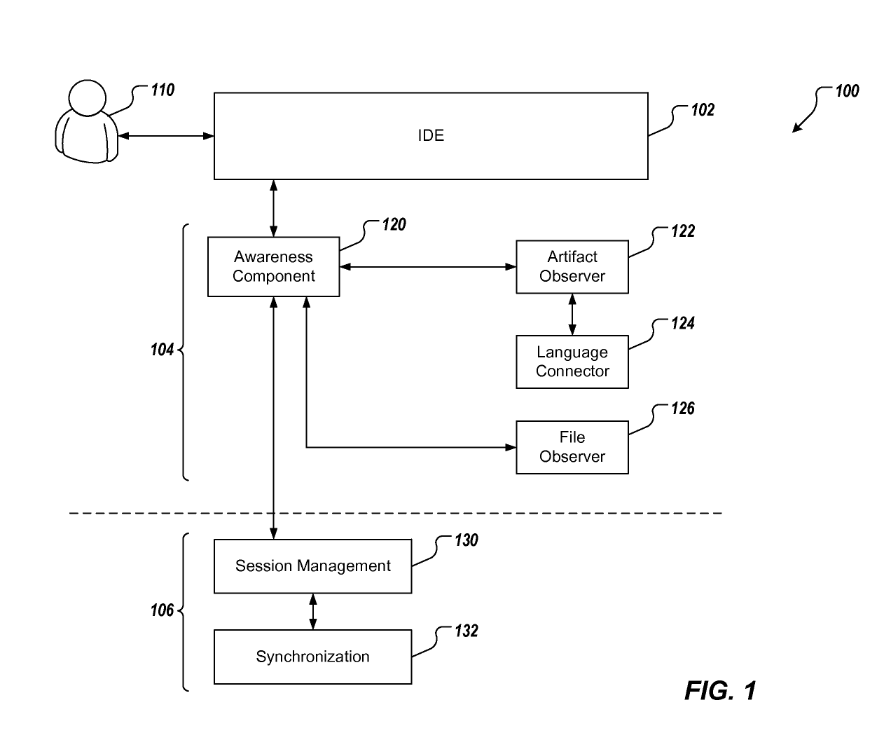

FIG. 1 depicts an example architecture 100 in accordance with implementations of the present disclosure. The example architecture 100 includes an IDE 102, a presence system 104, and a session system 106. As discussed in further detail herein, the presence system 104 monitors and analyzes activities related to source code access/changes by multiple developers. For example, a developer 110 can use the IDE 102 to access source code, e.g., through a version control system (VCS) (not shown). Other developers can concurrently access the same source code. In some examples, the presence system 104 can be informed of activities of other developers by the session system 106. In some examples, the presence system 104 can monitor activities of the developer 110 to provide information to other developers through the session system 106. In some examples, and as discussed in further detail below, the session system 106 synchronizes activity information between multiple developers, e.g., through respective presence systems 104 and IDEs 102.

In some examples, each of the components of the example architecture 100 is provided as one or more computer-executable programs that are executed by one or more computing devices. In some examples, the example architecture 100 can be realized in a client-server environment, in which components are implemented on a client-side and components are implemented on a server-side. In some examples, the client-side and the server-side communicate through a network. For example, the IDE 102 and the presence system 104 can be provided on a client-side, and the session system 106 can be provided on a server-side.

In some examples, the IDE 102 provides comprehensive facilities to developers for software development. Example IDEs can include a source code editor, build automation tools, a debugger, a compiler and/or an interpreter. An example IDE includes Eclipse provided by the Eclipse Foundation. In accordance some implementations, the IDE 102 can include side-panels, plug-ins, and/or entries in context menus that enrich the IDE 102 with presence and awareness functionality, discussed in further detail herein. In some examples, a VCS can track changes in a software project during a development process. In some examples, the VCS can include revision control to track and manage changes to software components in a distributed development process. Example VCSs can include Apache Subversion provided by the Apache Software Foundation, and Perforce provided by Perforce Software, Inc.

In the depicted example, the presence system 104 includes an awareness component 120, an artifact observer 122, a language connector 124, and a file observer 126. In some examples, the awareness component 120 provides presence and awareness information to the IDE 102 for display to the developer 110. In some examples, the information can be displayed as text and/or visual indicators, e.g., color, bold, underline, italics, icons. In some examples, status can be indicated in the form of text codes and/or visual codes or icons. In some examples, the awareness component 120 receives information from the session system 106, processes the information and provides presence and awareness information for display within the IDE 102.

In some implementations, the file observer 126 monitors, which files, e.g., source code files, are accessed by the developer 110 through the IDE 102. The file observer 126 can provide file information to the session system 106, e.g., through the awareness component 120. Example information can include file name, change status, and saved status.

In some implementations, the artifact observer 122 monitors activities associated with one or more code artifacts. The artifact observer 122 can provide status information based on the activities, as discussed in further detail below. In some examples, each code artifact of the one or more code artifacts is determined to be concurrently accessed by multiple developers. For example, the session system 106 can provide information that a particular code artifact is currently accessed by at least one developer. The developer 110 can also access the particular code artifact for editing in the IDE 102. In response, it can be determined that multiple developers are concurrently accessing the code artifact. Consequently, the artifact observer 122 can monitor activities of the developer 110 with respect to the particular code artifact.

In some examples, the artifact observer 122 can, for example, monitor the position of a cursor and/or identify portions of the code artifact that are being edited. In some implementations, the language connector 124 supports functionality provided by the artifact observer 122. In some examples, the language connector 124 provides contextual and semantic information that is particular to the programming language of the code artifact. In the example case of Java, the language connector 124 provides contextual and semantic information, such that the artifact observer can determine that a method, or a class are being edited, which are concepts that are specific to Java. In some examples, multiple language connectors 124 are provided, each language connector 124 being specific to a particular programming language.

In some examples, activity information is provided to the awareness component 120 from the IDE 102. Example activity information can include an identifier associated with a code artifact being accessed, e.g., class name, cursor position(s), and keystrokes. The awareness component 120 can provide the activity information to the artifact observer 122, which can process the activity information to provide status information. In some examples, the status information is particular to the code artifact being accessed. The artifact observer 122 provides the status information to the session system 106, e.g., through the awareness component 120.

In the depicted example, the session system 106 includes a session management component 130 and a synchronization component 132. In some implementations, the session management component 130 establishes a session between active developers. During the session, collaboration information, e.g., presence and awareness information, is exchanged between the developers, as discussed herein. In some examples, the session is specific to a code base that is being accessed by the developers. In some examples, the session is specific to a code artifact that is being accessed by the developers. In some implementations, the synchronization component 112 propagates status information between a plurality of awareness systems 104, each awareness system 104 being associated with a developer that is concurrently accessing source code. In some examples, the synchronization component 132 determines whether a file is in use by more than one developer, and propagates status information accordingly.

In some implementations, and as discussed above, status information associated with a code artifact can be provided to developers. Table 1, below, provides example status information that can be associated with code artifacts, and that can be provided to developers:

TABLE 1
Example Status Information

| Status | Description |
|---|---|
| Viewing | File containing code artifact is open within active tab or |
| | window of IDE |
| Opened | File containing code artifact is open within non-active tab |
| | or window of IDE |
| Changed and | Change(s) to the code artifact is locally saved, but not |
| Saved | committed to VCS |
| Changed | Change(s) to the code artifact, but not saved |
| Coding | Active change(s) to the code artifact |

In some implementations, presence and awareness information can be enhanced based on additional information. In some examples, additional information can be provided from internal and/or external information sources. Example internal information sources can include forums and/or discussion groups that are internal to an enterprise. In some examples, external information sources can include information sources that are not directly affiliated with an enterprise, e.g., company, institution, that is performing/supporting the development. Example external information sources can include computer-implemented social networking services, such as online forums and/or discussion groups, Twitter, Facebook, Google+, and the like.

In general, by providing a link to additional information sources, presence and awareness information can be enhanced. For example, a social networking profile associated with a developer can be provided a social networking service, e.g., Twitter, Facebook, Google+. In this manner, developers can be provided with a better understanding of the background and/or experience of other developers concurrently working on development projects.

To this end, a link can be provided between the developer and information sources, e.g., computer-implemented social networking services, publicly available websites, and the like. In some examples, one or more connectors (not shown) can be provided that enable communication with respective information sources, e.g., social networking services. In some examples, the connectors enable the IDE 102 to interact with application programming interfaces (APIs) of respective information sources.

To illustrate implementations of the present disclosure, an example progression resulting in presence and awareness information being displayed to a developer will be described.

A first developer, e.g., the developer 110, can log into a first IDE, e.g., the IDE 102. A second developer can log into a second IDE. The first developer can access a source code file using the IDE. For example, the first developer can check-out the source code file from a VCS, and can open a local copy of the source code file within the IDE for editing. For example, the first developer can open a code artifact, and can begin editing the artifact. An artifact observer, e.g., the artifact observer 122, and a file observer, e.g., the file observer 126, can monitor activities performed by the first developer with respect to the source code file and/or the code artifact. The first developer can actively edit the source code. Consequently, a status of the source code can include “Coding.”

The second developer can also access the source code file using the IDE. For example, the second developer can check-out the source code file from a VCS, and can open a local copy of the source code file within the IDE for editing. For example, the second developer can open a code artifact. An artifact observer and a file observer can monitor activities performed by the first developer with respect to the source code file and/or the code artifact.

In some examples, and in response to multiple developers accessing the source code file, a session system, e.g., the session system 106, can establish a session associated with the source code file. For example, the session system can coordinate status information associated with activities of the respective developers, and can provide status information for display to the respective developers. For example, a first notification can be displayed to the first developer indicating that the second developer has also accessed the source code file, and an associated status, e.g., “Viewing,” or “Opened.” As another example, a second notification can be displayed to the second developer indicating that the first developer has also accessed the source code, changes made, e.g., “changed line X,” or “changing line X,” and an associated status, e.g., “Changed,” or “Coding.” The first developer can save changes to the local copy of the source code file. Consequently, the status provided in the second notification can be updated to “Changed and Saved.”

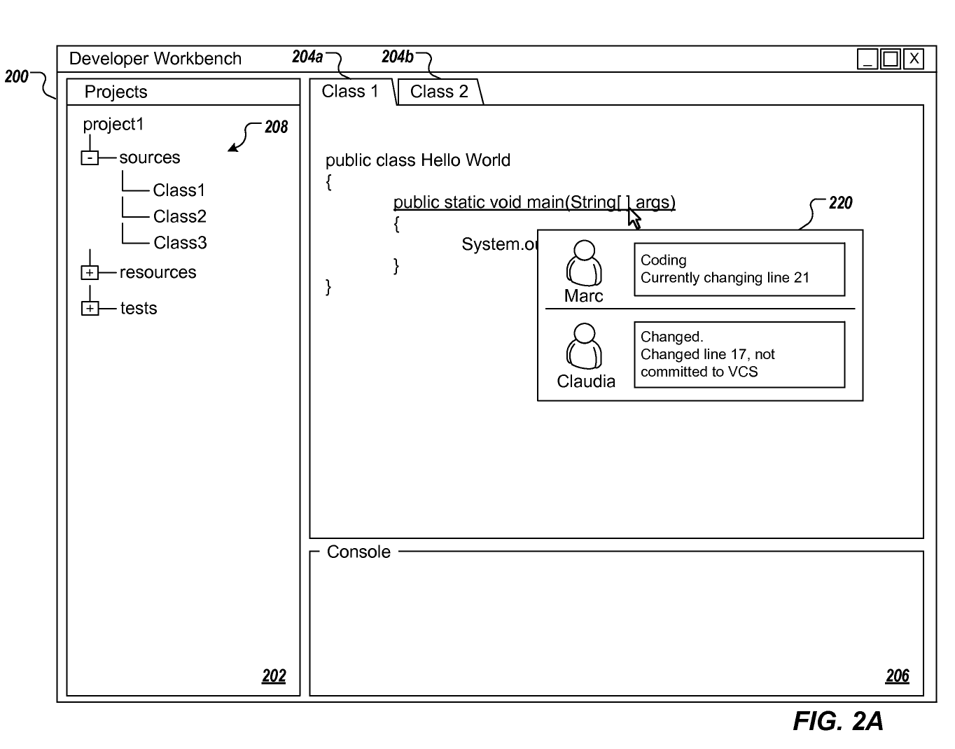

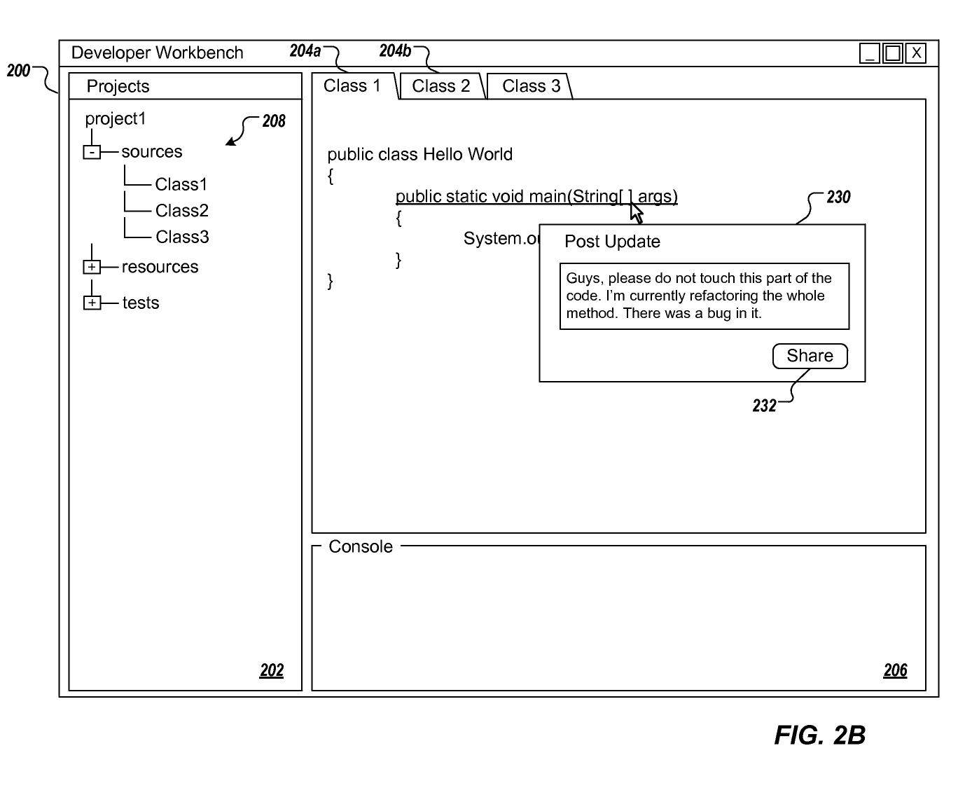

FIGS. 2A and 2B depict respective screen-shots in accordance with implementations of the present disclosure. FIG. 2A depicts a screen-shot of an example workbench 200 that can be displayed, e.g., by the IDE 102. In the depicted example, the workbench 200 includes a projects frame 202, tabs 204a, 204b, and a console frame 206. In the depicted example, the projects frame 202 displays a file tree that identifies one or more files, e.g., source code files, that can be opened. In this example, the “Class 1” and “Class 2” files have been selected by a developer and opened. Consequently, tab 204a is provided and is associated with “Class 1,” and tab 204b is provided and is associated with “Class 2.” In this example, the tab 204a can be provided as an active tab, e.g., opened and being viewed, and tab 204b can be provided as a non-active tab, e.g., opened, but not being viewed.

In the example of FIG. 2A, a notification 220 is displayed and provides presence and awareness information. More specifically, and in this example, the notification 220 reflects presence and awareness information associated with a method, “public static void main ( )” that is include in “Class 1.” The notification 220 indicates that the developer “Marc” is currently changing line 21 of the method. Consequently, the status associated with the method is provided as “Coding.” The notification 220 also indicates that the developer “Claudia” changed line 17 of the method, but the change has not yet been committed to the VCS.

In some examples, a developer viewing a notification can initiate communication with other developers. For example, a developer viewing the notification 220 can initiate communication with the developer “Marc” and/or the developer “Claudia.” In some examples, the notification 220 can be provided as a user interface that can received user input. For example, and in response to user input, a menu can be displayed that enables the developer to initiate a communication channel to other developers. Example communications channels can include a telephone call, an email, and an instant message.

FIG. 2B depicts a screen-shot of the example workbench 200. In the example of FIG. 2B, a developer can post an update to a code artifact to inform other developers of activities associated with the code artifact. For example, the developer can select the method, e.g., right-click on, to initiate a post update. In response to the developer selection, a post interface 230 is displayed. The post interface enables the developer to input a message that is to be associated with the code artifact. In the depicted example, the developer is requesting that other developers do not access/edit the method. The developer can commit this message to the code artifact, e.g., by clicking a button 232. Consequently, any time a developer access “Class 1,” the message provided in the post interface 230 can be displayed. In some examples, the developer that established the message, can subsequently delete the message, e.g., after the activity has been performed, refactoring in the displayed example.

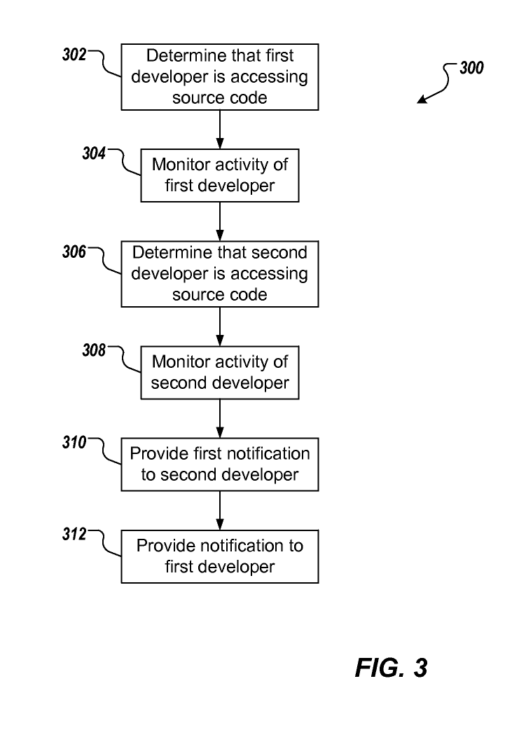

FIG. 3 depicts an example process 300 that can be executed in accordance with implementations of the present disclosure. In some examples, the example process 300 can be provided as one or more computer-executable programs executed using one or more computing devices. For example, the example architecture 100 of FIG. 1 can execute processes for supporting concurrent activities in distributed development processes.

It is determined that a first developer is accessing source code (302). For example, a first developer can use an IDE to check-out source code from a VCS. In some examples, the first developer can open a local copy of the source code for viewing and/or editing. Activity of the first developer is monitored (304). For example, viewing and/or editing of source code can be monitored. It is determined that a second developer is accessing the source code (306). For example, a second developer can use an IDE to check-out the source code from the VCS. In some examples, the second developer can open a local copy of the source code for viewing and/or editing. Activity of the second developer is monitored (308). For example, viewing and/or editing of source code can be monitored. A notification is provided to the second developer (310). For example, a synchronization system synchronizes activities of the first developer and the second developer, and the notification is provided to inform the second developer of activities of the first developer and a status of the source code. A notification is provided to the first developer (312). For example, the synchronization system synchronizes activities of the first developer and the second developer, and the notification is provided to inform the first developer of activities of the second developer and a status of the source code.

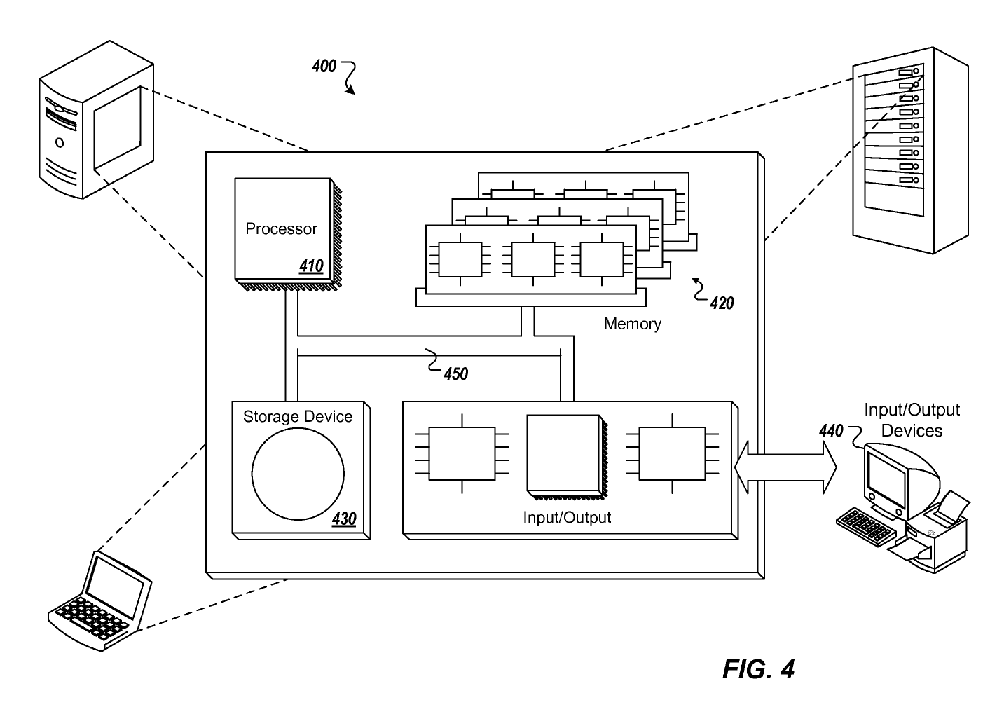

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit. The storage device 430 is capable of providing mass storage for the system 400. In one implementation, the storage device 430 is a computer-readable medium. In various different implementations, the storage device 430 may be a floppy disk device, a hard disk device, an optical disk device, or a tape device. The input/output device 440 provides input/output operations for the system 800. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for supporting concurrent activities in distributed development processes, the method being executed using one or more processors and comprising:
providing, by the one or more processors, source code for display to a first developer;
receiving, by the one or more processors, first status information associated with the source code, the first status information being received in response to a determination that a second developer is concurrently accessing the source code, and reflecting a first status of the source code;
processing, by the one or more processors, the first status information to provide first collaboration information; and
providing, by the one or more processors, the first collaboration information for display to the first developer.

2. The method of claim 1, wherein the first collaboration information is specific to a code artifact that is associated with the source code.

3. The method of claim 1, wherein the first collaboration information comprises an indication of the second developer.

4. The method of claim 1, wherein the first collaboration information comprises the status of the source code.

5. The method of claim 4, wherein the first status comprises one of a viewing status indicating that the source code is open within an active window displayed to the second developer, and an opened status indicating that the source code is open within a non-active window displayed to the second developer.

6. The method of claim 4, wherein the first status comprises one of a changed status indicating that at least one change has been made to the source code by the second developer, and a coding status indicating that the second developer is actively changing the source code.

7. The method of claim 1, further comprising:
monitoring activity of the first developer with respect to the source code; and
providing second status information reflecting the activity of the first developer.

8. The method of claim 7, wherein the second status information is provided to display second collaboration information to the second developer, the second collaboration information indicating the activity of the first developer.

9. The method of claim 1, wherein the status information is received from a synchronization system.

10. The method of claim 1, further comprising determining that a post has been associated with the source code, and in response providing post information in the first status information, the post information being included in the first collaboration information displayed to the first developer.

11. The method of claim 1, wherein the first status information reflects the first status based on activities of the second developer.

12. A non-transitory computer-readable storage medium coupled to one or more processors and having instructions stored thereon which, when executed by the one or more processors, cause the one or more processors to perform operations for supporting concurrent activities in distributed development processes, the operations comprising:
providing source code for display to a first developer;
receiving first status information associated with the source code, the first status information being received in response to a determination that a second developer is concurrently accessing the source code, and reflecting a first status of the source code;
processing the first status information to provide first collaboration information; and
providing the first collaboration information for display to the first developer.

13. A system, comprising:
a computing device; and
a computer-readable storage device coupled to the computing device and having instructions stored thereon which, when executed by the computing device, cause the computing device to perform operations for supporting concurrent activities in distributed development processes, the operations comprising:
providing source code for display to a first developer;
receiving first status information associated with the source code, the first status information being received in response to a determination that a second developer is concurrently accessing the source code, and reflecting a first status of the source code;
processing the first status information to provide first collaboration information; and
providing the first collaboration information for display to the first developer.
